(19) United States
(12) Patent Application Publication
(10) Pub. No.: US 2007/0201735 A1
(43) Pub. Date: Aug. 30, 2007

(54) Method and apparatus for the improved automatic detection of salient features in medical image data

(76) Inventor: Lutz Gundel, Erlangen (DE)

Correspondence Address: HARNESS, DICKEY & PIERCE, P.L.C., P.O.BOX 8910, RESTON, VA, 20195, US

(21) Appl. No.: 11/709,061

(22) Filed: Feb. 22, 2007

(30) Foreign Application Priority Data
Feb. 23, 2006 (DE) 10 2006 008 509.4

(51) Int. Cl. G06K 9/00

(52) U.S. Cl. 382/128

(57) ABSTRACT

A method and an apparatus are disclosed for automatically detecting salient features in medical image data of a body area of a patient. In an embodiment of the method, a number of image data records of the body area that are to be examined for salient features are provided and are automatically examined on an image computer with the aid of a detection algorithm to detect salient features in the image data records. The image data records are registered in the case of an embodiment of the present method to obtain transformations with the aid of which image regions in one of the image data records are assigned to corresponding image regions in other ones of the image data records that represent the same site of the body area. Upon the detection of a salient feature in one of the image data records, the image region in the other image data records that corresponds to the same site of the body area is checked for the presence of a salient feature, or is visualized to the user, this being done automatically on the basis of the transformations or upon input from a user. An embodiment of the present method and the associated apparatus substantially reduce for the user the time outlay in automatically detecting salient features in medical image data.

### PRIORITY STATEMENT

The present application hereby claims priority under 35 U.S.C. §119 on German patent application number DE 10 2006 008 509.4 filed Feb. 23, 2006, the entire contents of which is hereby incorporated herein by reference.

### FIELD

Embodiments of the present invention generally relate to a method and/or an apparatus for automatically detecting salient features in medical image data of a body area of a patient. For example, in the case of one example embodiment of a method and apparatus, a number of image data records of the body area that are to be examined for salient features are provided and are automatically examined on an image computer with the aid of a detection algorithm in order to detect salient features in the image data records.

### BACKGROUND

Medical imaging is used in the most varied diagnostic problems in order to support the diagnosis for a patient. It is true that diagnostically relevant salient features can be detected by an experienced user in the recorded image data, but with users who are still inexperienced there is the risk of such salient features being overlooked because of an image quality that is not always optimal. Known for the purpose of reducing this problem are methods in the case of which an automatic detection of lesions in the recorded image data is carried out with the aid of so-called CAD (Computer Aided Detection) tools. In this case, the image data records are firstly generated and stored with the aid of an imaging method. Examples of such methods are computer tomography, magnetic resonance tomography or mammography.

With the aid of detection algorithms, the image data records are subsequently searched on an image computer for specific structures that are characteristic of the lesions being sought. The result is displayed to the user. The latter then decides on the basis of his medical knowledge whether it is a lesion (true positive) or an erroneously found (false positive) structure that is involved. Suitable detection algorithms are known, for example, for automatically detecting lesions of the intestines, the lung or the breast. Further algorithms, for example for detecting liver and bone lesions as well as pulmonary embolisms, can be derived therefrom or are in the development stage. Examples of suitable detection algorithms are to be found in the specialist literature.

More than one image data record is worked with in some applications for automatically detecting lesions, for example when automatically detecting lesions of the colon. Here, pictures of the patient are made with the latter in the prone position and the supine position. The reconstructed image data records are then searched for lesions independently of one another. A lesion that is present can here be found either not at all, only in the first data record, only in the second data record or in both data records. If, for example, the user begins with the first data record and subsequently finds a lesion in the second data record, he must switch back to the first data record and monitor whether this lesion has likewise previously been discovered in the first data record. If lesions are detected in both data records, the user must check whether the same lesion is really involved. This leads in both instances to an increased work outlay.

Intravenous contrast agent is administered when carrying out liver examinations with the aid of a computer tomograph. The computer tomograph is then used to carry out various scans at different times, specifically before the administration of contrast agent, in the phase of enrichment of the contrast agent in the liver arteries, in the phase of enrichment in the liver veins, and in a so-called late venous phase. Use is made in this case of the fact that specific lesions are enriched with contrast agent in different ways on the basis of their vessel supply. The method for automatically detecting lesions has in this case previously been applied to these up to four image data records, there being a need for the above checking to take place in each case. However, this likewise entails an undesirably high outlay for the user.

In many applications, follow-up examinations are carried out after a specific period. A check is made in these follow-up examinations as to whether the size of existing lesions has changed, or whether further lesions have been added. After the automatic detection of lesions in the respective new image data records, this likewise requires an expensive comparison of these image data records with one or more passed image data records.

### SUMMARY

In at least one embodiment, the present invention includes a method and/or an apparatus for automatically detecting salient features in medical image data records that facilitates the comparison of the results for the user.

In the case of at least one embodiment of the present method, a number of image data records of the body area that are to be examined for salient features are provided and are automatically examined on an image computer with the aid of a detection algorithm in order to detect salient features in the image data records. Suitable detection algorithms are known to the person skilled in the art from the specialist literature.

At least one embodiment of the present method is distinguished in that the image data records are registered with one another in order to obtain, by way of this registration, geometric transformations with the aid of which image regions in one of the image data records are assigned to corresponding image regions, that represent the same site of the body area, in the other one or ones of the image data records. In the case of volume image data records, each voxel of an image data record can be projected by means of these transformations onto the corresponding voxel of the other image data records. If only two image data records are available, there is thus a need for only one transformation. In the case of more than two image data records, a number of transformations are obtained that enable the image regions to be assigned between desired ones of these image data records.

CAD results from a number of image data records can be correlated with one another by way of this registration, and need not be individually checked by the user. Thus, in the case of at least one embodiment of the present method upon the detection of a salient feature in one of the image data records, the image region in the other image data records that corresponds to the same site of the body area is checked for the presence of a salient feature, or is visualized to the user, this being done on the basis of the transformations either automatically or upon input from a user. This enables a check as to whether a lesion found in one of the image data records is present at all at the corresponding image position in the other image data record or records.

In the examination of the liver, for example, this plays an important role in which the information relating to a lesion that has been obtained from the various phases of the contrast enrichment is important for a diagnosis and must therefore be found and jointly displayed. This information can be used, for example, to state the type of a tumor.

The registration of the image data records can be performed in the case of at least one embodiment of the present method and of at least one embodiment of the associated apparatus with the aid of known methods of registration. Thus, for example, the registration can be carried out with the aid of artificial or natural landmarks that can be detected in the individual image data records. When carrying out the imaging recordings with the same equipments in direct sequence, such a registration can also be performed on the basis of the known recording parameters. Of course, further known registration methods that can be applied to the image data records are also possible.

In addition to the memory unit for storing a number of image data records of the body area, at least one embodiment of the present apparatus also includes a registration module, at least one examination module, a control unit and an output unit. The registration module is designed for registering the image data records and supplies transformations with the aid of which the image regions in one of the image data records are assigned corresponding image regions in the respective other image data records that represent the same site of the body area. These image regions are individual pixels or voxels or groups of these pixels or voxels.

The examination module of at least one embodiment includes at least one detection algorithm with the aid of which the image data records are automatically searched in order to detect salient features in the image data records. Upon the detection of a salient feature in one of the image data records, the control unit checks the image region in the other image data record or records that corresponds to the same site of the body area for the presence of a salient feature, this being done on the basis of the transformation automatically or upon input from the user, or visualizes the corresponding image region of the other image data record or records to the user on the output unit.

With the aid of at least one embodiment of the present method and the associated apparatus, after the automatic detection of a lesion by the detection algorithm the user need no longer check the already searched image data records as to whether this lesion has already been detected there. Rather, this is carried out automatically by the image computer in the case of at least one embodiment of the present method and at least one embodiment of the associated apparatus. Here, either the result of the comparison is communicated to the user, or the corresponding image region of the one or several other image data records is displayed to him on a screen. This greatly facilitates for the user the detection of salient features in medical image data, and thereby substantially reduces the associated time outlay.

A further substantial advantage results in the carrying out of follow-up investigations. In the case of such investigations, it is possible on the basis of the results already to hand from the preliminary investigations and of the transformation obtained from the registration to navigate at once to the image region in the new image data record or records at which the previously known lesion would have to be detectable. It is possible here for the user to have this image region automatically displayed without himself having to search therefor. A change in size of the lesion can be detected quickly and reliably in this way.

In the case of newly found lesions, it is likewise possible to check automatically whether the relevant lesion was already present in the image data records of the examinations previously carried out, and was simply overlooked, for example. A direct visualization of the relevant region of the image data records also facilitates the modal procedure in this case.

The image data records to be examined that are provided in at least one embodiment of the present method can originate in principle from different, preferably tomographic imaging methods. In of an example refinement of at least one embodiment of the present method and of at least one embodiment of the associated apparatus, these image data records with a computer tomograph are denoted as volume data records. The pictures for the different image data records can be produced here, for example, at different times for and/or after a contrast agent injection. This depends respectively on the medical application, in particular on the type of the salient features to be detected. These salient features can be, for example, lesions, embolisms, stenoses, pulmonary parenchyma diseases, osteoporosis, aneurysms, polyps of the intestines or anatomical malformations.

### BRIEF DESCRIPTION OF THE DRAWINGS

The present method and the associated apparatus are explained briefly again below with the aid of an example embodiment in conjunction with the drawings, in which:

FIG. 1 shows schematically an example of the method sequence in the case of an embodiment of the present method, and

FIG. 2 shows a schematic illustration of an embodiment of the present apparatus.

### DETAILED DESCRIPTION OF THE EXAMPLE EMBODIMENTS

It will be understood that if an element is referred to as being “on”, “against”, “connected to”, or “coupled to” another element, then it can be directly on, against, connected or coupled to the other element, or intervening elements may be present. In contrast, if an element is referred to as being “directly on”, “directly connected to”, or “directly coupled to” another element, then there are no intervening elements present.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, steps, etc., it should be understood that these elements, components, steps, etc. should not be limited by these terms. These terms are used only to distinguish one element, component, step, etc. from another. Thus, a first element, component, step, etc. discussed below could be termed a second (or other) element, component, steps, etc. without departing from the teachings of the present invention.

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described. Like numbers refer to like elements throughout. As used herein, the term “and/or” includes any and all combinations of one or more of the associated listed items.

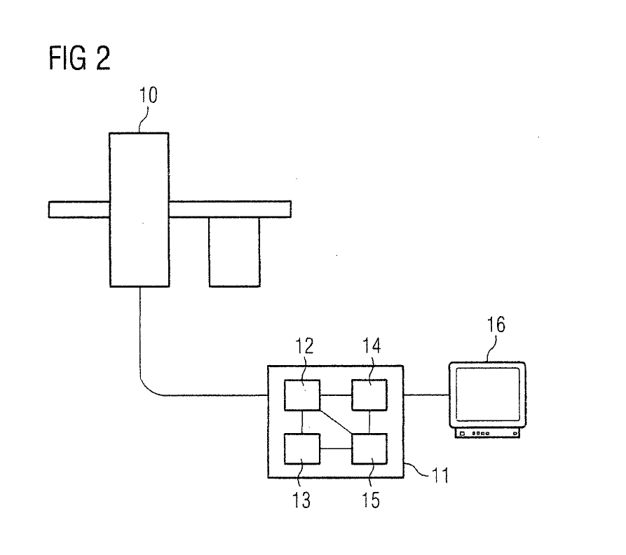

An embodiment of the present method is to be explained below on the example of two CT image data records that were recorded from a body area of a patient at different times after a contrast agent injection. After the recording of the raw data by the computer tomograph 10, the two image data records 1 and 2 were reconstructed from these raw data and stored in the memory unit 12 of an image computer 11 that is designed as an apparatus in accordance with the present invention (compare FIG. 2). The two image data records are subsequently registered in the registration module 13 of the image computer 11 on the basis of the known recording geometry with the aid of which the two image data records 1 and 2 were recorded.

This registration provides a transformation matrix by means of which each voxel of one image data record can be assigned a voxel of the other image data record that represents the same site in the recorded body area of the patient. Thus, for each voxel of one image data record that has been identified as belonging to a lesion it is possible to find the corresponding voxel in the other image data record in an automatic fashion on the basis of the transformation matrix.

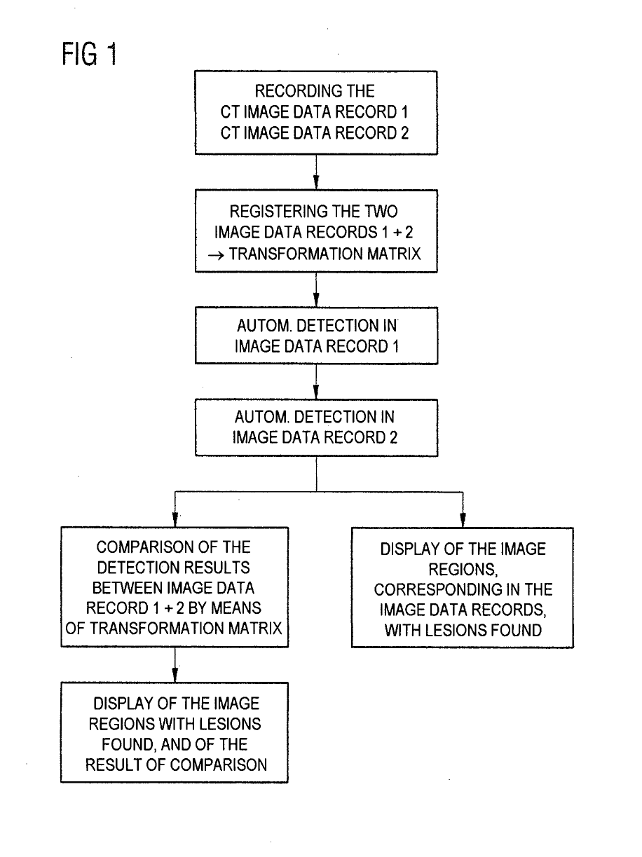

After the registration, the first step in an embodiment of the present method is to search the first image data record 1 automatically for lesions by means of a detection algorithm of the examination module 14, as indicated in FIG. 1. Any possible detected lesions are either shown directly to the user on the monitor 16 of the image computer 11, or firstly stored with the information relating to the location on the lesion. Subsequently, the second image data record 2 is automatically examined in the same way. If a lesion is found in the second image data record 2, the control module 15 uses the transformation matrix to check whether a lesion has already been registered at the same location in the first image data record 1, and informs the user of the result via the monitor 16. The corresponding image region, known on the basis of the transformation matrix, of the first image data record 1 can here be displayed to the user simultaneously for monitoring purposes on the monitor 16.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for automatically detecting salient features in medical image data of a body area of a patient, comprising:
providing a number of image data records of the body area that are to be examined for salient features;
detecting salient features in the provided image data records by examining the provided image data records on an image computer with the aid of a detection algorithm;
registering the image data records to obtain transformations with the aid of which image regions in one of the image data records are assigned to corresponding image regions in other ones of the image data records that represent the same site of the body area; and
at least one of checking, upon the detection of a salient feature in one of the image data records, the image region in the other image data records that corresponds to the same site of the body area for the presence of a salient feature, and visualizing the image region in the other image data records that corresponds to the same site of the body area to the user, this being done automatically on the basis of at least one of the transformations and upon input from a user.

2. The method as claimed in claim 1, wherein CT pictures, that have been recorded at different times at least one of before and after a contrast agent injection, are provided as image data records of the body area.

3. The method as claimed in claim 1, wherein CT pictures that originate from temporally separate examinations of the patient are provided as image data records of the body area.

4. The method as claimed in claim 1, wherein CT pictures that have been recorded in different positions of the patient are provided as image data records of the body area.

5. The method as claimed in claim 1, wherein the image data records are examined automatically for at least one of lesions, embolisms, stenosis, pulmonary parenchyma diseases, osteoporosis, aneurysms, and anatomical malformations as salient features.

6. An apparatus for automatically detecting salient features in medical image data of a body area of a patient, comprising:
a memory unit to store a number of image data records of the body area;
a registration module to register the image data records, which supplies transformations with the aid of which image regions in one of the image data records are assigned to corresponding image regions in other ones of the image data records that represent the same site of the body area;
at least one examination module to automatically examine the image data records with the aid of a detection algorithm to detect salient features in the image data records;
a control module to at least one of, upon the detection of a salient feature in one of the image data records, check the image region in the other image data records that corresponds to the same site of the body area for the presence of a salient feature, and visualize the image region in the other image data records that corresponds to the same site of the body area to the user, this being done automatically on the basis of at least one of the transformations and input from a user; and
an output unit to display the result of at least one of the checking and the visualization.

7. The apparatus as claimed in claim 6, wherein the examination module is designed for automatically detecting at least one of lesions, embolisms, stenosis, pulmonary parenchyma diseases, osteoporosis, aneurysms, and anatomical malformations as salient features.

8. The method as claimed in claim 2, wherein CT pictures that originate from temporally separate examinations of the patient are provided as image data records of the body area.

9. The method as claimed in claim 2, wherein CT pictures that have been recorded in different positions of the patient are provided as image data records of the body area.

10. The method as claimed in claim 2, wherein the image data records are examined automatically for at least one of lesions, embolisms, stenosis, pulmonary parenchyma diseases, osteoporosis, aneurysms, and anatomical malformations as salient features.

11. An apparatus for automatically detecting salient features in medical image data of a body area of a patient, comprising:
means for storing a number of image data records of the body area;
means for registering the image data records, which supplies transformations with the aid of which image regions in one of the image data records are assigned to corresponding image regions in other ones of the image data records that represent the same site of the body area;
means for automatically examining the image data records with the aid of a detection algorithm to detect salient features in the image data records;
means for at least one of, upon the detection of a salient feature in one of the image data records, checking the image region in the other image data records that corresponds to the same site of the body area for the presence of a salient feature, and visualizing the image region in the other image data records that corresponds to the same site of the body area to the user, this being done automatically on the basis of at least one of the transformations and input from a user; and
means for displaying the result of at least one of the checking and the visualization.

12. The apparatus as claimed in claim 11, wherein the means for automatically examining is designed for automatically detecting at least one of lesions, embolisms, stenosis, pulmonary parenchyma diseases, osteoporosis, aneurysms, and anatomical malformations as salient features.
